(19) United States
(12) Patent Application Publication
(10) Pub. No.: US 2009/0263037 A1
(43) Pub. Date: Oct. 22, 2009

(54) Method and Apparatus for Enhancing the Dynamic Range of an Image

(75) Inventors: Guoping Qiu, Fotan (HK); Wei Zhang, Clear Water Bay (HK); Huajun Peng, Tai Po (HK); Min Chen, Kowloon (HK)

Correspondence Address: WELLS ST. JOHN P.S., 601 W. FIRST AVENUE, SUITE 1300, SPOKANE, WA, 99201, US

(73) Assignee: Hong Kong Applied Science and Technology Research Institute Company Limited

(21) Appl. No.: 12/105,505

(22) Filed: Apr. 18, 2008

(51) Int. Cl. G06K 9/40

(52) U.S. Cl. 382/254

(57) ABSTRACT

A method of converting an image signal from an original dynamic range to a target dynamic range includes dividing the original dynamic range and the target dynamic range in to a plurality of corresponding sub-ranges and mapping each original sub-range to its corresponding target sub-range. One of the dynamic ranges is divided into a plurality of sub-ranges having equal size and the other dynamic range is divided into the corresponding sub-ranges each having a size based on a characteristic of the corresponding equal size sub-ranges. The invention may be employed in display, capture and image processing apparatus.

### FIELD OF THE INVENTION

The present invention relates to method and apparatus for enhancing the dynamic range of an image. In particular the invention relates to a method of enhancing the luminance dynamic range of an image signal.

### BACKGROUND

Luminance is a measure of luminous intensity or the amount of light that is emitted from a particular area and so luminance translates into the perceived brightness of a scene or image. The range of luminance in the real world is continuous in both brightness and time and can reach up to 14 orders of magnitude (10 to the power 14) from starlight to sunlight. The human eye can see a wide luminance range of up to 5 orders of magnitude. It is relative straightforward to generate high dynamic range (HDR) images. For example, photographs can contain the entire dynamic range of a scene by applying multiple exposure times. Digital cameras that can capture high dynamic range scenes become popular. However, most display means only have a capability of display a scene of 2 to 3 orders of magnitude. A luminance mapping, known as tone mapping, can be used to map from the dynamic range of the real world to the lower dynamic range of electronic display devices. Alternatively, many Algorithms and graphic technologies have developed to compress the dynamic range of a HDR scene to a displayable range. One merit of the tone mapping is to optimize the data volume of video stream in the pipeline.

Recent developments in LCD display technology have resulted in displays that can show images with a high luminance dynamic range. However, as many images are converted to a lower luminance dynamic range before the images are rendered in the display, there is a need for a reverse process of increasing the luminance dynamic range of a digital image for use with these high dynamic range displays. The most straightforward way to enlarge the dynamic range is simply multiple a constant to each pixel intensity value. However, such linear stretch does not consider the image characteristic and human visual system property. Moreover, the linear scaling up approach may cause artifacts, such as introducing contouring effect into gradually changing regions.

There is also a trend towards viewing video and images on portable electronic devices such as mobile phones, PDAs and game machines. Although it is desirable for these devices to portrait high resolution and high dynamic range images such factors as cost, design, constraints and battery life may dictate that the display device used in portable devices operates at a lower resolution and illumination dynamic range than a standard display screen such as a television or computer monitor.

Accordingly, it is an object of the present invention to provide a method and an image-processing device for enhancing the dynamic range of an image signal.

### SUMMARY OF THE INVENTION

In the current invention a method of converting an image signal from an original dynamic range to a target dynamic range includes dividing the original dynamic range and the target dynamic range in to a plurality of corresponding sub-ranges and mapping each original sub-range to its corresponding target sub-range. The mapping functions or algorithms used to map between each of the original sub-ranges to the corresponding target sub-ranges need not, and preferably are not, the same.

In obtaining the sub-ranges, one of the dynamic ranges, that is to say either the original dynamic range or the target dynamic range, is divided into a plurality of sub-ranges having equal size and the other dynamic range is divided into the corresponding sub-ranges each having a size based on a characteristic of the corresponding equal size sub-ranges.

The invention also includes display, capture and image processing apparatus employing the method.

Further aspects of the invention will become apparent from the following description, which is given by way of example only.

### BRIEF DESCRIPTION OF THE DRAWINGS

An exemplary form of the present invention will now be described by way of example only and with reference to the accompanying drawings, in which:

FIG. 1 graphically illustrates a first exemplary embodiment of a method of dividing original and target dynamic ranges into sub-ranges prior to tone mapping,

FIG. 2 graphically illustrates tone mapping of sub-ranges of FIG. 1,

FIG. 3 graphically illustrates a second exemplary embodiment of a method of dividing original and target dynamic ranges into sub-ranges prior to tone mapping,

FIG. 4 is a block diagram of a first exemplary example of a high dynamic range display apparatus,

FIG. 5 graphically illustrates dividing a low dynamic range and target high dynamic range into sub-ranges in the display apparatus of FIG. 4, and

FIG. 6 is a block diagram of a second exemplary example of a high dynamic range display apparatus

### DESCRIPTION OF THE EXEMPLARY EMBODIMENTS

Reference will now be made in detail to exemplary embodiments of the present invention, examples of which are illustrated in the accompanying drawings. The method relates to a method of enhancing the luminance dynamic range of an image or image signal. The image or image signal may be a static image or a video image. The method is typically used when converting the bit-depth or bits-per-pixel of the image, for example converting from an 8-bit image to 16-bit image or visa versa, but this is not critical to the invention and the method may be used to enhance the luminance dynamic range of an image without changing the image bit-depth.

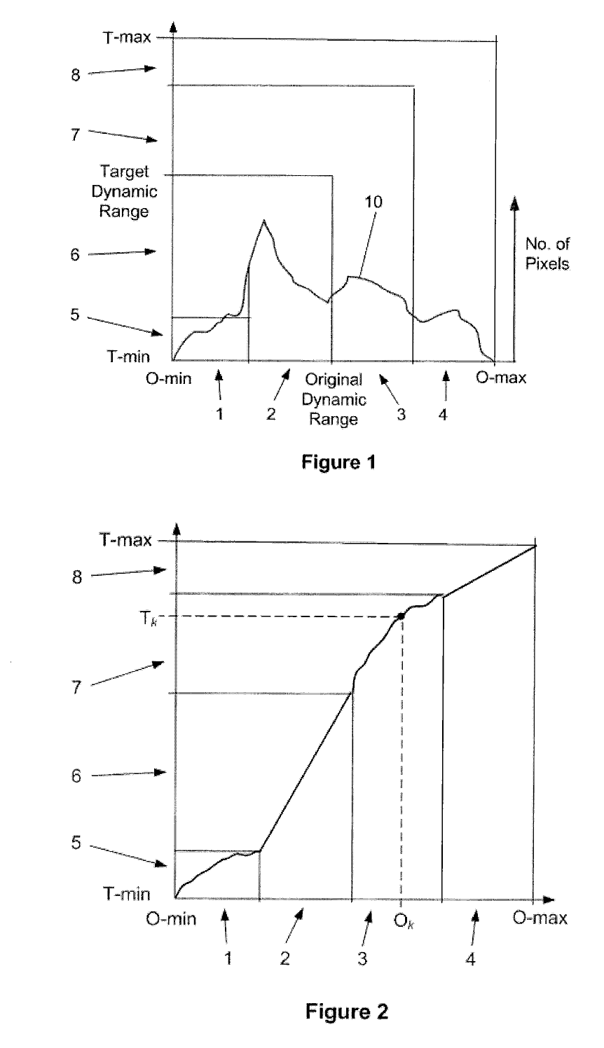

FIGS. 1 through 3 illustrate a method of enhancing the luminance dynamic range of an image according to the invention. The bit-depth of the image is not considered and may remain constant or increase or decrease. FIG. 1 shows an image histogram having along the horizontal x-axis an original luminance dynamic range of pixels in the image from a minimum value (O-min) to a maximum value (O-max). On the vertical y-axis is the target luminance dynamic range a minimum value (T-min) to a maximum value (T-max). A secondary y-axis to the right of the histogram represents a number of pixels. Luminance is a measure of luminous intensity or the amount of light that is emitted from a particular area and so luminance translates into the perceived brightness of the image, which is represented by each pixels Luma (luminance) or grayscale level. The histogram plot 10 represents a population or number of pixel in the image signal having a luminance value on the x-axis. The luminance range along the x-axis is divided into four luminance sub-ranges 1, 2, 3 and 4 each having an equal size (or dimension). The number of pixels having a luminance value falling within each sub-range varies as is apparent from the image histogram. The target dynamic range on the y-axis is divided into a corresponding number of four target sub-ranges 5, 6, 7, 8.

The size, or dimension, of each of the target sub-ranges 5, 6, 7, 8 is dynamic and not necessarily equal. The size of the each target sub-ranges is dependant on a characteristic of the original sub-ranges 1, 2, 3, 4 which in the case of the exemplary embodiment is the number of pixels having a luminance that falls within each of the original sub-ranges 1, 2, 3, 4. So for example, in FIG. 1 sub-range 2 has the largest population of pixels and so corresponding target sub-range 6 has the largest size or dimension. The original sub-range 3 has the second largest population of pixels and so corresponding target sub-range 7 has the second largest size or dimension of the target sub-ranges. Likewise target sub-ranges 5 and 8 have a size or dimension based on the pixel population in corresponding original sub-ranges 1 and 4. Put another way, the size of each target sub-range is a proportion of the entire target dynamic range corresponding to the population of pixels in the corresponding original sub-range as a percentage of the total number of pixels in the image. Thus, according to this first exemplary embodiment the original dynamic range is divided into equal sized sub-ranges and the target dynamic range is dynamically divided into a corresponding number of target sub-ranges each having a size directly proportional to the number of pixels having intensity values within the corresponding original sub-range.

With reference to FIG. 1, assuming that the original dynamic range is equally divided into 4 sub ranges, 1, 2, 3, 4, and assuming that the number of pixels falling onto the sub ranges are N(1), N(2), N(3) and N(4) respectively, the size or dimension of the target sub ranges, 5, 6, 7 and 8 are respectively S(5), S(6), S6, and S(8), one possible way to set the target sub range dimension is as follows

$$S ( 5 ) = \frac{N ( 1 ) ( {T}_{max} - {T}_{min} )}{N ( 1 ) + N ( 2 ) + N ( 3 ) + N ( 4 )}$$

$$S ( 6 ) = \frac{N ( 2 ) ( {T}_{max} - {T}_{min} )}{N ( 1 ) + N ( 2 ) + N ( 3 ) + N ( 4 )}$$

$$S ( 7 ) = \frac{N ( 3 ) ( {T}_{max} - {T}_{min} )}{N ( 1 ) + N ( 2 ) + N ( 3 ) + N ( 4 )}$$

$$S ( 8 ) = \frac{N ( 4 ) ( {T}_{max} - {T}_{min} )}{N ( 1 ) + N ( 2 ) + N ( 3 ) + N ( 4 )}$$

Referring to FIG. 2, after the size of each original sub-range and corresponding target sub-range is determined an appropriate tone-mapping function of the form Tₖ=F(Oₖ) is used to map each original luminance value Oₖ in the original luminance dynamic range to a corresponding target luminance value Tₖ in the target dynamic range. The mapping function F used to map luminance values in each pair of sub-ranges need not be the same and could be either linear or non-linear. In the embodiment illustrated in FIG. 2 a linear mapping function used to map original sub-range 2 to target sub-range 7 and original sub-range 4 to target sub-range 5, and non-linear mapping function is used to map original sub-range 1 to target sub-range 5 and original sub-range 3 to target sub-range 7. It is envisaged that any tone-mapping function known in the art could be utilized to map the original sub-range to the target sub-range. One method of tone mapping each original sub-range to its corresponding target sub-range can be found in co-inventors early patent application Ser. No. 11/809,095 filed 31 May 2007, the entire contents of which are incorporate herein by reference.

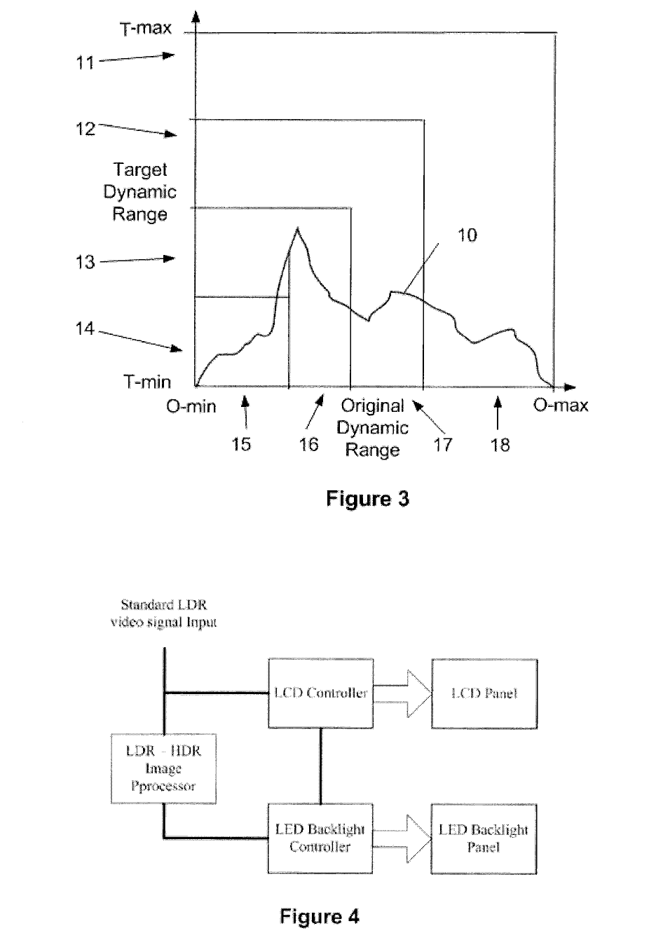

FIG. 3 illustrates a second exemplary embodiment of the invention wherein the target dynamic range on the vertical y-axis is divided into equal sized sub-ranges 11, 12, 13, 14. The size or dimension of the corresponding original target sub-range 15, 16, 17, 18 is dynamically chosen dependant upon a particular characteristic of the image histogram which in the illustrated embodiment is again the number of pixels having an intensity value within the original sub-ranges. In this case, the size or dimension of the original sub-ranges 15, 16, 17, 18 is chosen so that the population, or number, of pixels in each original sub-range is the same. Again, once the original sub-ranges 15, 16, 17, 18 and target sub-range 11, 12 13 14 sizes are determined then any known tone mapping method can be used to map pixel intensities from the original sub-range to the corresponding target sub-range.

Assuming that the target sub rages are divided into 4 equal size sub ranges, 15,16, 17, and 18, and their corresponding sub range in the input dynamic ranges are 11, 12, 13, and 14 respectively and their sizes are S(11), S(12), S(13) and S(14) respectively, and the number of pixels falling with 11, 12, 13, and 14 are N(11), N(12), N(13) and N(14) respectively, one possible way to set the size or dimension of 11, 12, 13, and 14 is by minimizing the following objective function

$$\{ S ( 11 ) , S ( 12 ) , S ( 13 ) , S ( 14 ) \} = arg ( min ( {\sum }_{i = 1}^{4} {( S ( i ) - \frac{{O}_{max} - {O}_{min}}{4} )}^{2} - λ {\sum }_{i = 1}^{4} {( N ( i ) - \frac{1}{4} {\sum }_{j = 1}^{4} N ( j ) )}^{2} ) )$$

where 0<□<1 is a constant value. This optimization can be solved by using a method similar to that proposed by G Qiu, J. Guan, J. Duan and M. Chen, “Tone mapping for HDR image using optimization—A new closed form solution”, ICRP 2006, 18th International Conference on Pattern Recognition, 20-24 Aug. 2006, Hong Kong

One benefit of dividing the original and target dynamic ranges into sub-ranges according to the invention and tone mapping each sub-range separately is that the dynamic range of the sub-ranges into which the greatest number of pixels fall is expanded while the dynamic range of those sub-ranges have a small population of pixels is compressed. This improves the contrast and detail in the major parts of the image without changing the order of magnitude or the overall luminance dynamic range.

A typical example of where the current invention may find application is when a standard image is to be displayed on a high dynamic range display device. The inventors have already proposed in an earlier application Ser. No. 11/707,517 filed on 16 Feb. 2007 a liquid crystal display device having a dynamic backlight that can improve the contrast and bit depth of luminance dynamic range of the display output. The contents of said application Ser. No. 11/707,517 filed on 16 Feb. 2007 are incorporated herein by reference. In a preferred embodiment of the current invention this liquid crystal display device includes an image luminance processor for increasing the dynamic range of a received low luminance dynamic range (LDR) image so that the image can be displayed by the device in a higher luminance dynamic range format to improve viewable contrast and detail in the image.

In FIG. 4 of the drawings there is shown a block diagram of a high luminance dynamic range display device, generally identical to that disclosed in application Ser. No. 11/707,517 filed on 16 Feb. 2007. The display device has a variable intensity backlight device for providing backlighting to a liquid crystal display (LCD) panel. The LCD panel has a plurality of light transmissive display elements. An LCD controller controls the light transmittance of the light transmissive display elements. The LCD controller receives a standard low dynamic range (LDR) image and controls the light transmittance of each light transmissive display element accordingly as is known in the art of LCD displays. The backlight device for the LCD panel has a backlight panel on which there is mounted a plurality of light emitting diodes and a backlight controller for individually controlling illumination of the LEDs. The device also includes an image processor for converting the LDR image into a high dynamic range (HDR) image for input to the backlight controller. A backlight controller receives the HDR image and analyses the HDR image to generate output signals for the LEDs to individually control LED brightness. By individually controlling the brightness of each LED in combination with the transmittance of a corresponding LCD element the viewed luminance dynamic range of each element of the display device is increased from that of a conventional constant backlit LCD display and the image is viewable as a HDR image.

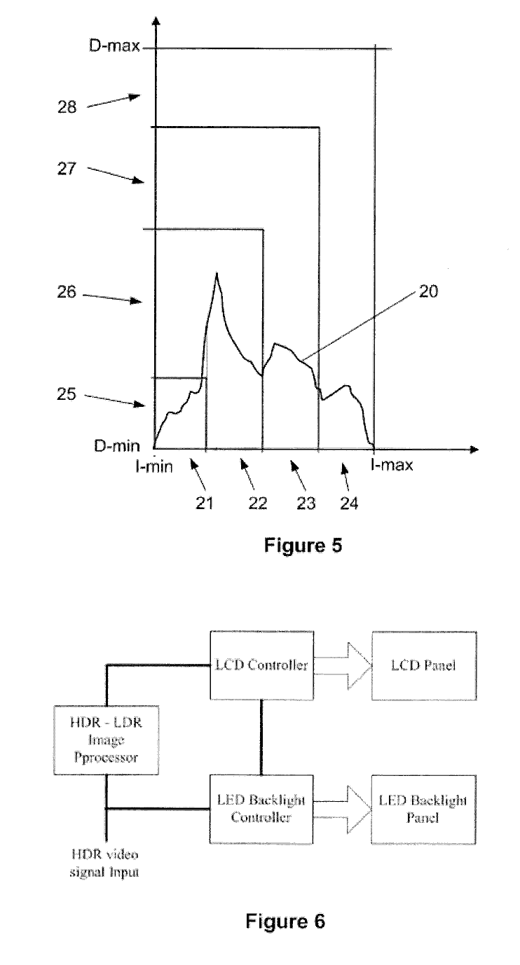

The following discussion describes how the image processor uses a method according to the current invention in conversion of the LDR image signal to a HDR image signal for the LCD displayer. FIG. 5 shows an image histogram having along the horizontal x-axis the luminance dynamic range of pixels in the LDR image signal from a minimum value (I-min) to a maximum value (I-max). Up the vertical y-axis is the target HDR corresponding to the display luminance dynamic range from a minimum value (D-min) to a maximum value (D-max). The display dynamic range is greater than the image dynamic range. The histogram plot 20 represents the population or number of pixels in the LDR image signal having a luminance value on the x-axis. The intensity range along the x-axis is divided into four intensity sub-ranges 21, 22, 23 and 24 each having an equal size (or dimension). The number of pixels having an intensity value falling within each sub-range varies as is apparent from the image histogram. The display dynamic range on the y-axis is divided into a corresponding number of four display sub-ranges 25, 26, 27, 28. The size of the display sub-ranges 25, 26, 27, 28 is chosen to each have a size directly proportional to the number of pixels having a grayscale or luminance level falling within a corresponding image sub-range as described earlier. After the size of each image sub-range and corresponding display sub-range is determined an appropriate tone-mapping function is used to map each image sub-range to its corresponding display sub-range individually. The tone-mapping function used to map each pair of sub-ranges need not be the same and could be either linear or non-linear. In contrast to the earlier example the dynamic range of all sub-ranges in this example is increased as a result of the overall increase in the dynamic range. However, this is merely a characteristic of this particular example and it is possible that the range of a particular sub-range my decrease even though the overall dynamic range increased.

An exemplary example of the invention has been described. However, it should be appreciated that modifications and alternations obvious to those skilled in the art are not to be considered as beyond the scope of the present invention. One such modification is shown in FIG. 6. It is envisaged that images already in a HDR format may be displayed on the device described in an earlier application Ser. No. 11/707,517 filed on 16 Feb. 2007. Such a device may include a HDR to LDR tone-mapping processor for converting the input HDR image to LDR format used by the LCD controller and panel. In such an example the target dynamic range would be smaller than the original dynamic range.

What is claimed is:

1. A method in an image processing device of converting an image signal from an original dynamic range to a target dynamic range, the method comprising
dividing the original dynamic range in to a plurality of original sub-ranges,
dividing the target dynamic range in to a plurality of target sub-ranges, each original sub-range having a corresponding target sub-range, and
mapping each original sub-range to its corresponding target sub-range.

2. The method of claim 1 wherein dividing the original dynamic range in to a plurality of original sub-ranges comprises dividing the original dynamic range in to a plurality of original sub-ranges having equal size.

3. The method of claim 2 wherein dividing the target dynamic range in to a plurality of target sub-ranges comprises dividing the dynamic range in to a plurality of target sub-ranges each having a size based on a characteristic of its corresponding original sub-ranges.

4. The method of claim 3 wherein the characteristic is a number of pixels in the corresponding original sub-range.

5. The method of claim 1 wherein dividing the target dynamic range in to a plurality of target sub-ranges comprises dividing the target dynamic range in to a plurality of target sub-ranges having equal size.

6. The method of claim 5 wherein dividing the original dynamic range in to a plurality of original sub-ranges comprises dividing the dynamic range in to a plurality of target sub-ranges each having a size based on a characteristic of its corresponding original sub-ranges.

7. The method of claim 6 wherein the characteristic is a number of pixels in the corresponding original sub-range.

8. The method of claim 1 wherein the original dynamic range is a range of image pixel intensities between a minimum and a maximum intensity and the target dynamic range is a range of image display device pixel brightness between a minimum and a maximum brightness.

9. A display apparatus for displaying an image, comprising:
an LCD panel having a plurality of light transmissive display elements,
an LCD controller for controlling light transmittance of the light transmissive display elements in response to a first image signal having an original dynamic range,
an LCD panel backlight having a plurality of light emitting devices for backlighting the light transmissive display elements,
a backlight controller for individually controlling illumination of the light emitting devices in accordance with a second image signal having a target dynamic range,
an image processor programmed to perform the method of claim 1 for converting a received image signal between the original dynamic range and the target dynamic range.

10. The display apparatus of claim 9 wherein dividing the original dynamic range in to a plurality of original sub-ranges comprises dividing the original dynamic range in to a plurality of original sub-ranges having equal size.

11. The display apparatus of claim 10 wherein dividing the target dynamic range in to a plurality of target sub-ranges comprises dividing the dynamic range in to a plurality of target sub-ranges each having a size based on a characteristic of its corresponding original sub-ranges.

12. The display apparatus of claim 11 wherein the characteristic is a number of pixels in the corresponding original sub-range.

13. The display apparatus of claim 9 wherein dividing the target dynamic range in to a plurality of target sub-ranges comprises dividing the target dynamic range in to a plurality of target sub-ranges having equal size.

14. The display apparatus of claim 13 wherein dividing the original dynamic range in to a plurality of original sub-ranges comprises dividing the dynamic range in to a plurality of target sub-ranges each having a size based on a characteristic of its corresponding original sub-ranges.

15. The display apparatus of claim 14 wherein the characteristic is a number of pixels in the corresponding original sub-range.

16. The display apparatus of claim 9 wherein the original dynamic range is a range of image pixel intensities between a minimum and a maximum intensity and the target dynamic range is a range of image display device pixel brightness between a minimum and a maximum brightness.

17. In an image processing device or image display device, a method of increasing the luminance dynamic range of a digital image to improve viewable contrast and detail in the image, the method comprising:
dividing an original dynamic range in to a plurality of original sub-ranges,
dividing a target dynamic range in to a plurality of target sub-ranges, each original sub-range having a corresponding target sub-range, and
mapping each original sub-range to its corresponding target sub-range.

18. The device of claim 17 wherein dividing the original dynamic range in to a plurality of original sub-ranges comprises dividing the original dynamic range in to a plurality of original sub-ranges having equal size.

19. The device of claim 18 wherein dividing the target dynamic range in to a plurality of target sub-ranges comprises dividing the dynamic range in to a plurality of target sub-ranges each having a size based on a characteristic of its corresponding original sub-ranges.

20. The device of claim 19 wherein the characteristic is a number of pixels in the corresponding original sub-range.

21. The device of claim 17 wherein dividing the target dynamic range in to a plurality of target sub-ranges comprises dividing the target dynamic range in to a plurality of target sub-ranges having equal size.

22. The device of claim 21 wherein dividing the original dynamic range in to a plurality of original sub-ranges comprises dividing the dynamic range in to a plurality of target sub-ranges each having a size based on a characteristic of its corresponding original sub-ranges.

23. The device of claim 22 wherein the characteristic is a number of pixels in the corresponding original sub-range.

24. The device of claim 17 wherein the original dynamic range is a range of image pixel intensities between a minimum and a maximum intensity and the target dynamic range is a range of image display device pixel brightness between a minimum and a maximum brightness.
